(19) United States
(12) Patent Application Publication
(10) Pub. No.: US 2010/0140518 A1
(43) Pub. Date: Jun. 10, 2010

(54) Valves Controlling Flow

(76) Inventor: David Robert Billings, Burlington (CA)

Correspondence Address: DAVID ROBERT BILLINGS, 2302 WAGNER CRESCENT, BURLINGTON, ON, L7R-1S9, CA

(21) Appl. No.: 12/083,631

(22) PCT Filed: Oct. 24, 2006
(86) PCT No.: PCT/CA2006/001733

§ 371 Date: Apr. 16, 2008

Related U.S. Application Data
(60) Provisional application No. 60/730,667, filed on Oct. 28, 2005.

(51) Int. Cl. F16K 31/02

(52) U.S. Cl. 251/129.01

(57) ABSTRACT

Valves controlling flow of gas or liquid, where compressible material is trapped within a rigid housing to provide a leak-proof seal surrounding an longitudinally movable rigid shaft. Where the shaft has a hollow channel and perpendicular ports to the outer surface, it allows for on and off control and is called a hollow shaft valve. If the shaft has diametric reductions on its outer surface, the valve allows for variable control. Creating a series of hollow shaft valves and variable shaft valves on a single shaft allows multiple functions through a single seal to create a serial shaft valve. The technology also allows for the precise and indexed variable control of fluid flow through a variable shaft valve by having a bayonet style system to precisely actuate orifice size rather than a rotary handle. This arrangement has application in a wide variety of situations including chlorination valves. In the case of automobiles, the valve used to vent fuel in the case of an accident can be triggered by mechanical means, such as an airbag deployment sensor system.

### FIELD OF THE INVENTION

The present invention relates to valves controlling flow. In particular, the present invention relates to valves controlling flow of gas or liquid.

### BACKGROUND

The prior art suffers from the problems associated with multiple access points such as less reliability and lower performance. Valve venting technology in the prior art has not addressed the problem of collisions in a gaseous fuelled automobiles presenting the possibility of explosions with hydrogen vehicles. Applications to hydrogen fuel usage for automobiles must deal with the large range of explosiveness for hydrogen gas, 4% to 74%. For example, some recent work such as that of Jupp of Calgary teaches a means to monitor leakage of compressed cylinders but fails to teach the monitoring of working valves. Prior valve technology also suffers from imprecise control of orifice size for variable valves. This lack of precision can render some mixing processes such as small scale chlorination of drinking water from liquid chlorine solution impractical. The prior art also makes it difficult to make discrete records of indexed variable control valve settings.

Therefore, there is a need for valve which allows placement of multiple valve functions through a single access point on a pressurized container.

### SUMMARY OF THE INVENTION

In a preferred embodiment of the present invention, there is a valve controlling flow of gas or liquid comprising a housing having a wall with an inner surface, the inner surface defining a channel, a seal in said channel, a shaft movable longitudinally through said channel between a position that prevents flow to a position that permits flow, and, one or more means on said shaft for controlling flow through said seal.

The present invention provides a valve which has a wide variety of applications that require multiple valve functions through a single access point on a pressurized container.

In another aspect of the present invention, the means on said shaft for controlling flow through said seal is a diametric reduction of the shaft on one side of said seal and movement of the diametric reduction into said seal permits flow through the seal.

In another aspect of the present invention, the means on said shaft for controlling flow through said seal is a longitudinal channel within part of said shaft having two or more outlets perpendicular to the longitudinal axis of said longitudinal channel and longitudinal movement of the shaft controls flow through the longitudinal channel.

In another aspect of the present invention, longitudinal movement of the shaft causes at least two of said perpendicular outlets on opposite sides of said seal permit flow from one side of said seal to the other.

In another aspect of the present invention, longitudinal movement of the shaft aligns one or more perpendicular outlets with corresponding ports in said housing to permit flow through the seal.

In another aspect of the present invention, one or more corresponding ports are within said seal.

### BRIEF DESCRIPTION OF DRAWINGS

In drawings which illustrate by way of example only one embodiment of the invention,

FIG. 1 is a sectional view of a valve having a diametric reduction of part of the shaft with 1A showing the closed position and 1B showing the open position.

FIG. 2 is a sectional view of a valve having a hollow component of the shaft with 2A showing the closed position and 2B showing the open position.

FIG. 3 is a sectional view of a fuel fill valve including a fuel fill hose from the refueling station with 3A showing the fuel fill hose and the fuel fill valve when they are not attached, 3B showing them attached but with the bayonet not engaged to the bayonet groove and 3C showing the bayonet engaged and fuel flowing.

FIG. 4 is a top view of a multiple piece o-ring retainer

FIG. 5A is a sectional view of a multiple piece retainer seal with a partially conical chamber and a cylindrical seal of compressible material.

FIG. 5B is a sectional view of a multiple piece retainer seal with a partially conical compressible sleeve and a cylindrical chamber.

FIG. 6 is a sectional view of a retainer to hold compressible material made of two plugs.

FIG. 7 is a sectional view of an automobile's gaseous fuel control system where fuel filling and fuel control to the engine are in one port on the compressed gas cylinder while pressure relief during a collision and pressure relief during excess heat are on another port on the compressed gas cylinder.

FIG. 8 is a sectional view of a system as in FIG. 7 but where sensor wires are run through the hollow shaft valve and variable shaft valve

FIG. 9 is a sectional view of an automobile's fuel control system with a pressure relief spring inside the fuel shaft and a pressure relief pipe running through the compressible material retainer.

FIG. 10 is a sectional view of a fuel control system with the control shaft spring inside the gas cylinder and a monitoring system on the pressure relief pipe of FIG. 9. An array of small holes acts as a hollow shaft valve outlet port.

FIG. 11 is a sectional view of sintered pins acting as a hollow shaft valve outlet port for pressure relief.

FIG. 12 is a sectional view of a section of sintered metal acting as a hollow shaft valve outlet port.

FIG. 13 is a sectional view of a hose which acts as a spring which is part of the fuel control shaft and is supported from buckling on the inside by an inner hose support pipe and on the outside by an outer hose support pipe.

FIG. 14 is a sectional view of the pressure relief control housing for venting pressure during an automobile's collision through a test lever. FIG. 14A is a sectional view of the system in its resting position. FIG. 14B is a sectional view of the system when the collision signal has opened the vent. FIG. 14C is a sectional view of the system as the release solenoid has removed the lever From the notch to allow the system to return to the state shown in 14A.

FIG. 15 is a sectional view of a schematic of a fuel control system as the pressure relief from excess heat system compresses the hose which acts like a spring so that the probe pressure relief pipe can vent fuel.

FIG. 16 is a sectional view of the part of a fuel control system with an ignition off solenoid which provides resistance for the pressure relief system due to excess temperature and a switch to monitor that the performance of the ignition off solenoid.

FIG. 17 is a top view of the part of a fuel control system with an ignition off solenoid shown in FIG. 16 with a channel to guide the movement of the sensor wire tee joint

FIG. 18 is a sectional view of a variable shaft valve used for a public drinking fountain where the cork apparatus is stationary and the surrounding mechanism moves.

FIG. 19 is a sectional view of a non-automotive application of the variable shaft valve which controls the precisely controls the flow of one fluid into another fluid, such as the addition of one liquid to another or the mixing of cold water and hot water in process such as a personal shower. The valve is actuated by a bayonet system of shower control posts and post position maintenance grooves where the shower handle guide is cast as a single item.

Similar references are used in different figures to denote similar components.

### DETAILED DESCRIPTION

While the present invention can be used in various applications, one embodiment will be described with reference to a valve which controls the gas from a gas cylinder to a fuel line.

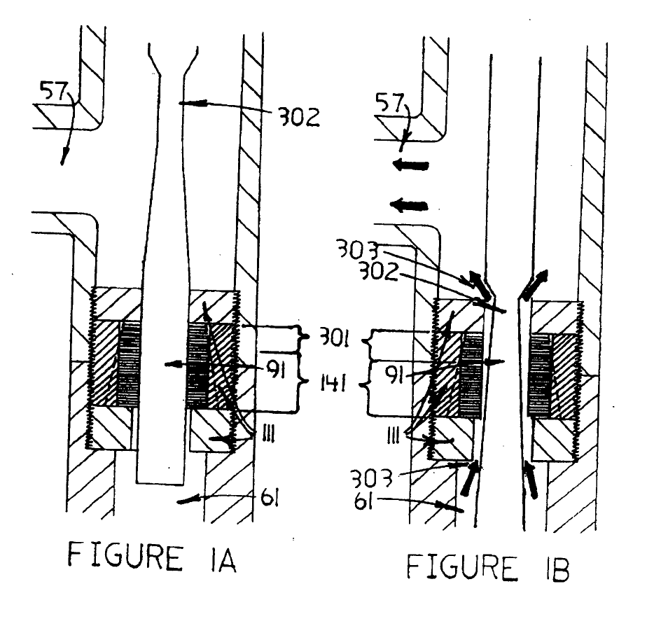

FIGS. 1A and 1B illustrate a valve having a diametric reduction in part of the shaft as its means for controlling flow through the seal. FIG. 1A shows a valve where the shaft is in the closed position in the channel. The valve controls the movement of gas from a gas cylinder (61) to the fuel line (57). A three piece retainer (111) creates a seal and puts pressure against the shaft before its diametric reduction and prevents gas flow. The shaft (91) in this figure is constructed of cork material. The partially conical shape of the compressible material is easy to insert in the three piece retainer (111). The three piece retainer (111) puts more pressure on the seal closest to the pressurized gas. The conical shape of the seal also puts gradually less pressure on the seal though the compression zone (141) until the zone without compression (301) stops deforming the compressible material. This helps prevent nibbling of the o-ring material. Maintaining a low coefficient of friction between the shaft (91) and the shaft before its diametric reduction also prevents nibbling and eases operation of movement of the shaft. The shaft (91) may be coated with polytetrafluorethylene (PTFE) to lower friction. Also, the partially conical compressible material before deformation (144) may also be made from polytetrafluorethylene (PTFE) or a similar low friction coefficient o-ring type of material.

In the closed position shown in FIG. 1A, the rigid three piece retainer (111) holds and compresses the shaft (91). In the embodiment shown, the three pieces are successively threaded into place. However, in other embodiments, the three pieces can be held together with bolts, or by using a hollow cylinder of compressible material compressed by a retainer with a partially conically shaped chamber. Some o-ring materials may be easily machined to the precise shape or also be cast.

FIG. 1B shows the operation of the same valve of FIG. 1A when the shaft has been moved in longitudinally through the channel in the housing from the closed position, being a position that prevents flow, to the open position, which is a position that permits flow. The diametric reduction (302) aspect of the shaft has been moved towards the seal, such that it prevents the formation of a seal with the three piece retainer (111). When the seal is lost, gas is allowed to flow through the orifice (303), thereby letting gas out of the gas cylinder (61) and into the fuel line (57). The position of the shaft (91) offers precise variable control of orifice size and thus, precise control of gas flow. The position of the shaft (91) may be actuated by a variety of means, including a by solenoid, by hand, by a rotary valve, or by a bayonet system as shown in FIG. 19. While FIGS. 1A and 1B show a diametric reduction around the entire circumference of the shaft (91), a diametric reduction could also be achieved by a cork groove (92) cut into a cross section of the cork apparatus (91) as shown in FIG. 19. The cork groove (92) could be in a spiral to vary the section the diametric reduction or could have stepwise variations in depth. The diametric reduction of the shaft could also be achieved by having a tapered diametric reduction of all of the shaft.

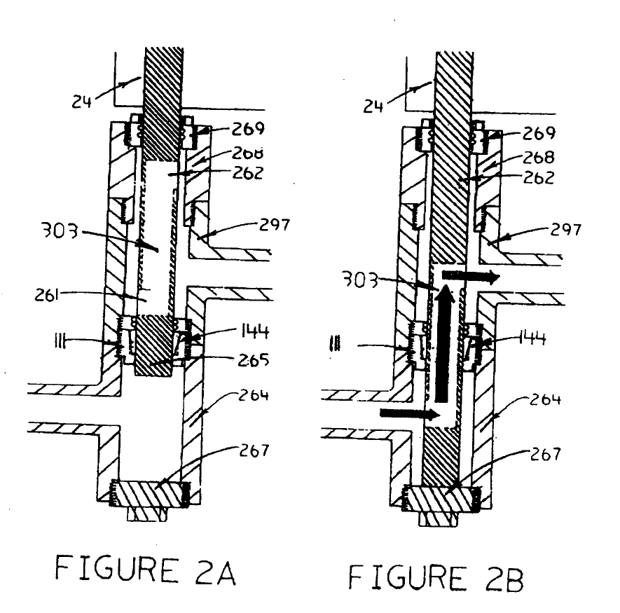

In yet another embodiment of the present invention, FIGS. 2A and 2B show a valve having a shaft with a longitudinal channel in part of the shaft and two perpendicular outlets. FIG. 2A is a sectional view of a valve having a longitudinal channel component of the shaft with 2A showing the closed position and 2B showing the open position. In this particular embodiment, the valve controls the flow of fluid. In FIG. 2A, the hollow shaft valve stops the flow of fluid from a pipe flow hollow shaft valve inlet tee (264) to a pipe flow hollow shaft valve outlet tee (297). There is a three piece retainer (111) with a partially conical compressible material before deformation (144), which provides a sealing action against the longitudinal channel tube tip (265) to prevent fluid leakage. Other seals in the valve are also provided by the pipe flow hollow shaft valve inlet flow plug (267), the pipe flow longitudinal channel outlet extension (268) and the pipe flow hollow shaft valve outlet extension two piece compressible material retainer (269).

FIG. 2B shows the shaft with the longitudinal channel when it has been moved to the open position. Although in this particular embodiment, the shaft is moved by the pressure relief control housing (24), other means to move the shaft can be employed. The valve has a longitudinal channel (303) within it which connects to the fluid outside by two ports, the hollow shaft valve inlet port (261) and the hollow shaft valve outlet port (262). When the two ports are on opposite sides of the seal, as shown in FIG. 2B, fluid flows in an on-off manner from the inlet (264) to the outlet (297).

The valves having a shaft with diametric reduction and valves having a longitudinal channel within part of the shaft can be combined to provide multiple fluid control actions through a single leak proof seal of compressible material. Multiple valves having a longitudinal channel within part of the shaft may also be combined on a single shaft in series. Multiple variable shaft valves may also be placed on a single shaft in series. Having a single opening in a pressurized container for multiple valve functions can increase safety and reliability while reducing costs.

The valve of the present invention can be used to control the flow of gaseous fuels such as hydrogen, propane or natural gas in vehicles. Such vehicles would include automobiles, trucks, heavy equipment, buses, forklifts or mining equipment. Underground mining equipment could have separate oxygen and hydrogen tanks to reduce the mines ventilation burdens. Pressure relief during the collision of underground vehicles may not be advisable. Gaseous fuel applications could include internal combustion engines, fuel cells, gaseous fuel diesel engines or their hybrids.

FIG. 4 is a top view of a multiple piece o-ring retainer which comes in two halves; a male o-ring retainer half (323) and a female o-ring retainer half (324). O-rings may function as back up seals. They might also be full seals for low performance applications. For ease of removing the two piece o-ring retainer from the opening to the pressure vessel two maintenance posts (134) may extend vertically from the flat surface and may double as disc supports. The outer thread (133) is coated with a gas fitting rope or a gas fitting tape.

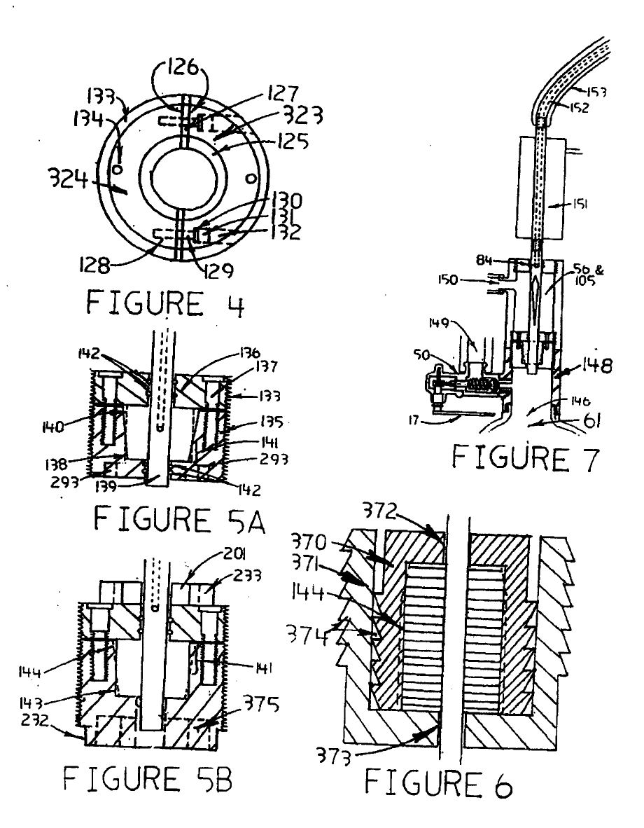

FIG. 5A is side view of the seal of the valve, illustrated in this embodiment as a multiple piece retainer. In particular, FIG. 5A shows a pair of two piece o-ring retainers, the upper two piece o-ring retainer (136) and the lower two piece o-ring retainer (135) held together by machine screws (137). The o-rings (142) in this embodiment function mainly as a backup seal. The polytetrafluorethylene (PTFE) tube tip (139) can help reduce erosion due to its low coefficient of friction. The lower two piece o-ring retainer (135) has a partially conical chamber (138) drilled into it. Into this chamber, is placed the compressible cylindrical sleeve (140). In the drawing the compressible cylindrical sleeve before deformation (140) is shown in its shape before deformation by the dotted lines to show how a section of sleeve compression (141) will be compressed by the confines of the partially conical chamber (138). This differs from FIGS. 1 and 2 where the chamber was cylindrical and the sleeve was partially conical. The sleeve is preferably made of some material commonly used for o-ring composition such as Nitrile, Fluorocarbon Type A, Silicone, Ethylene Propylene, perfluoroelastomer, Chloroprene, Urethane, Flourosilicone, Polytetrafluorethylene (PTFE) Encapsulated or Polytetrafluorethylene (PTFE).

FIG. 5B shows another embodiment of the seal as a multiple piece sleeve retainer (111). In this embodiment, there is a cylindrical chamber (143) and a partially conical compressible sleeve before deformation (144) to create a section of sleeve compression (141).

FIG. 6 is a sectional view of a retainer to hold compressible material. In this seal, the inner pipe plug (370) is placed inside an outer pipe plug (371) and creates a chamber which holds the partially conical compressible material before deformation (144). An outer plug receptacle (373) and an inner plug receptacle (372) allows the shaft entry into and out of the retainer. While plastic pipe having outer ridges (374) are shown in this embodiment, the surfaces could also be threaded.

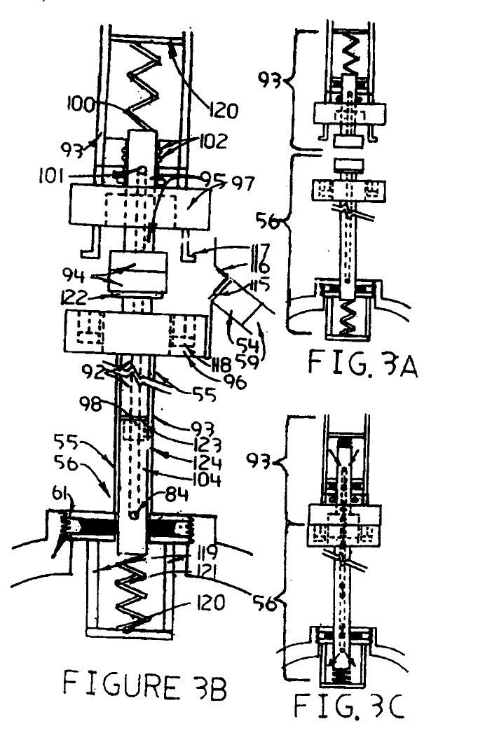

In yet another embodiment of the present invention, a valve having a hollow shaft can be used to transfer fuel in an on off manner as seen in FIGS. 3A, 3B, and 3C and can be used in both the fuel fill valve (56) in the fuel fill hose (93). However, automobile fuel tanks are usually low to the ground. This requires that the fuel fill channel (55) be fairly long for the ergonomic convenience of the person filling the tank. A hollow extension pipe called the fragile tube tip extension (92) threads onto the fuel fill valve tube tip (104) at the fuel fill valve thread (98) where a compressible gasket (123) prevents leaks. This effectively extends the fuel fill valve tube tip (104) up the fuel fill channel (55) to a height which is ergonomically comfortable for the driver when refilling the car. However, The fragile tube tip extension (92) is made of some fragile material, such as plastic or aluminium or perhaps a flexible hose. In the event of an accident it will break without damaging the fuel fill valve (56) which is safely inside the gas cylinder safety collar. The fuel fill channel (55) surrounds the fragile tube tip extension (92) and is narrow enough provide snug guidance. The fuel fill channel (55) should have a fuel pipe service opening (124) at the bottom. This facilitates easy maintenance of the fuel fill valve tube tip (104), especially for the removal of broken fragile tube tip extensions (92). The fuel fill valve tube tip spring (121) is supported by a disc (120) and a disc support (119). The disc (120) in the fuel fill hose (93) may be similar or it may use the walls of the fuel fill hose (93) as support. The upper end of the fragile fuel tip extension (92) is fitted with a standard quick connect gas fitting (94). The filling station's fuel fill hose (93) is fitted with a matching standard quick connect gas fitting (94). The fuel fill channel (55) is fitted with a fuel fill pipe retainer ring (96) which matches the fuel fill hose retainer ring (97). FIG. 3A shows the filling stations fuel fill hose (93) and the car's fuel fill valve (56) when they are not connected. Once the two standard quick connect gas fittings (94) are joined as in FIG. 3B, an open shaft exists for potential fuel flow from the fuel fill hose tube tip (95), to the cylinder plug port (84). However, in this state no fuel will flow. The tube tip spring (119) keeps the cylinder port (84) on the side of the o-ring (82) away from the gas cylinder (61). Like wise, the fuel hose hollow shaft valve spring (100) keeps the fuel hose hollow shaft valve inner port (101) away from fuel inside the fuel fill hose (93). FIG. 3B shows a fuel hose o-ring (102). However a compressible sleeve as in FIGS. 3A and 3C may be more durable and practical.

However, when the fuel fill pipe retainer ring (96) is connected to the fuel fill hose retainer ring (97) the distance between the fuel fill hose (93) and the fuel fill valve (56) is decreased as shown in FIG. 3C. This could be done with a thread between the fuel fill pipe retainer ring (96) and the fuel fill hose retainer ring (97). However, a bayonet type mounting system with a bayonet (117) on the fuel fill hose (93) and matching bayonet grooves (118) is preferred since it would allow a greater displacement to occur in a lesser period of time. The bayonet (117) is a couple of posts with perpendicular protuberances. These protuberances enter the bayonet grooves (118) by rotating the fuel fill hose (93). The decreased distance forces the fuel fill valve cylinder port (84) into the gas cylinder (61) at the same time the fuel fill hose hollow shaft valve inner port (101) accesses fuel in the fuel fill hose (93) to allow fuel to flow into the automobile.

Since the flow of gas disconnects at the standard quick connect gas fittings (94), there will be a constant supply of gas within the limited volume of the fragile tube tip extension (92). It is recommended that the fragile tube tip extension (92) have a hexagonal fragile tube tip extension head (122) either in the fuel pipe service opening (124) or behind the standard quick connect gas fitting which can tighten the fragile tube tip extension (92) against a washer between it and the fuel fill valve tube tip (104).

The fragile tube tip extension (92) may also filter incoming fuel by containing a fuel filling pipe filter made of some porous material which traps dust but which allows the passage of hydrogen gas. The fuel filling pipe filter is not shown in the drawing. Easy replacement of this filter is a desirable design feature.

In yet another embodiment of the present invention, FIG. 3B shows a valve design of pressure relief pipe (59) which conducts venting gases of the system to a whistle (54) having a rain guard (115) held in place by a rain guard spring (116) such that a sound is emitted whenever the system emits gas.

In yet another embodiment of the present invention, FIG. 7 shows a tee shaped gas cylinder tap (148) which allows for a fuel fill valve (56) to be combined with a fuel shut off variable shaft valve (105) with a pressure relief valve (50) which can be actuated in an emergency by a solenoid latching system motivating the test lever (17) all with a single gas cylinder port (146). The solenoid latching system is not shown in FIG. 7. This embodiment allows the control equipment to all be placed within the gas cylinder safety collar which is not shown in FIG. 7. The flexible fuel fill extension hose (152) is strong enough to motivate the cylinder plug port (84) but flexile enough to travel through the fuel fill extension hose guide (153) when it is actuated by the variable shaft valve solenoid (151). The pressure relief hose (149) and the fuel line to engine hose (150) help absorb the automobile's vibrations to the system. The gas cylinder (61) may be prevented from damage by placing a roll bar system beneath the vehicle. This roll bar system could be fitted with removable bullet proof panels.

Each port on a compressed fluid vessel is: a source of potential leakage and unreliability, a cost of manufacture and a complication during repairs. The automotive embodiment of this invention requires multiple functions including: sensor wire access, fuel filling, control of fuel to the engine during operation, pressure relief due to excess pressure such as in a fire, and emergency pressure venting during an accident.

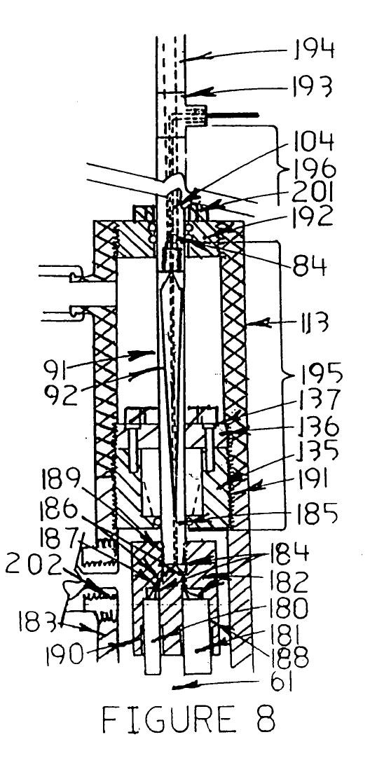

In yet another embodiment of the present invention, FIG. 8 shows sensors placed inside of the gas cylinder (61) without creating a separate port for each of them. Two critical sensors are the gas pressure sensor (180) and the oxygen sensor (181). The gas pressure sensor (180) and the oxygen sensor (181) are mounted in a gas cylinder probe (182) which is mounted to the tip of the cork apparatus (91) which has cork grooves (92), preferably by threads. Each sensor has a custom fit hole drilled for it in the gas cylinder probe (182) with a gas dope chamber (184) where a dose of gas fitting dope acts as a seal. A shaft through the cork apparatus (91) called the sensor wire conduit (185) goes from one end of the cork apparatus (91) to the other. All of the sensor wires (186) run through this sensor wire conduit (185) through the end of the cork apparatus (91). Gas cylinder probe conduits (187) are drilled though the gas cylinder probe (182) to join the threaded probe cavity (189) to each sensor cavity (188). Sensor adhesive (190) keeps the sensors in place in the gas cylinder probe (182). The fuel fill valve tube tip (104) has a fuel fill hollow shaft valve outlet port (84). The threads of the lower two piece o-ring retainer (135) and the upper two piece o-ring retainer (136) act to join the variable shaft valve housing (113) and the gas cylinder neck (183) by the gas cylinder neck threads (191). The variable shaft valve housing o-ring retainer (192) prevents leakage from the variable shaft valve housing (113) whose contained pressure will be less than that of the gas cylinder (61).

The sensor wires (186), run through the sensor wire tee joint (193) which is threaded onto the fuel fill valve tube tip (104) and the fuel fill valve tube union (194). The sensor wire tee joint (193) may be placed anywhere in the system but preferably have a sensor wire tee joint traveling distance (196) which is greater than the distance from the cylinder port to the gas cylinder (195). The sensor wires must have free play to accommodate the sensor wire tee joint traveling distance (196).

Like the embodiment shown in FIG. 7, FIG. 8 also has a pressure relief tee joint (202) which has a separate port for pressure relief than the port for fuel filling, sensor wires and fuel flow to the engine.

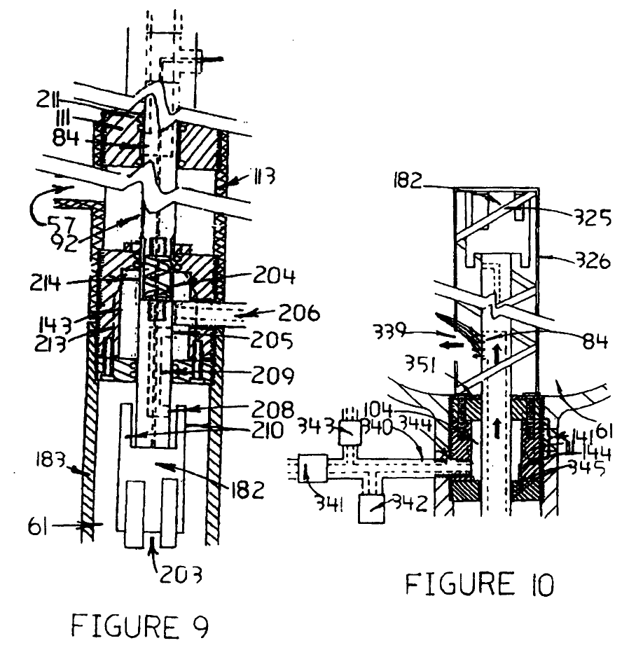

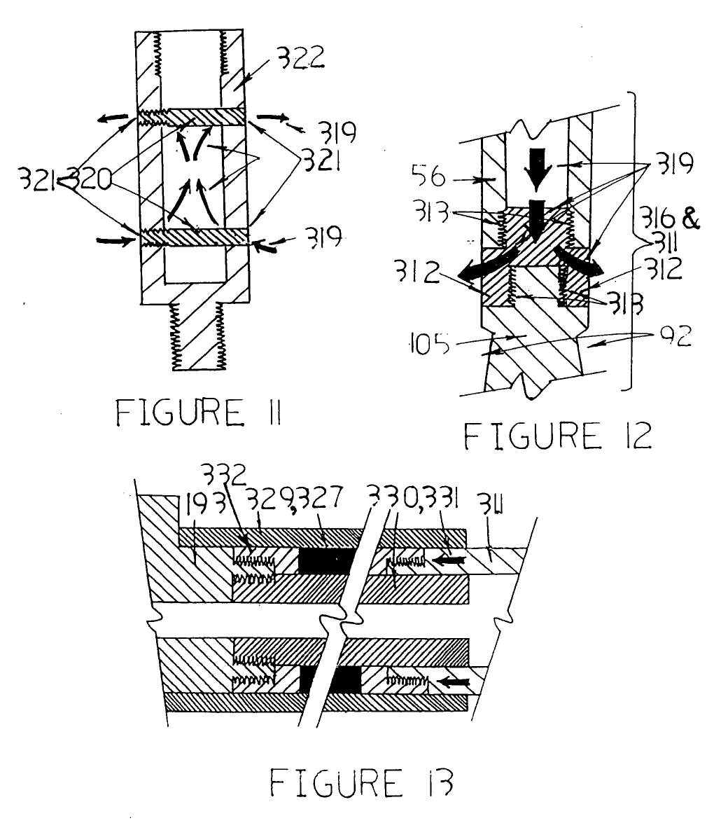

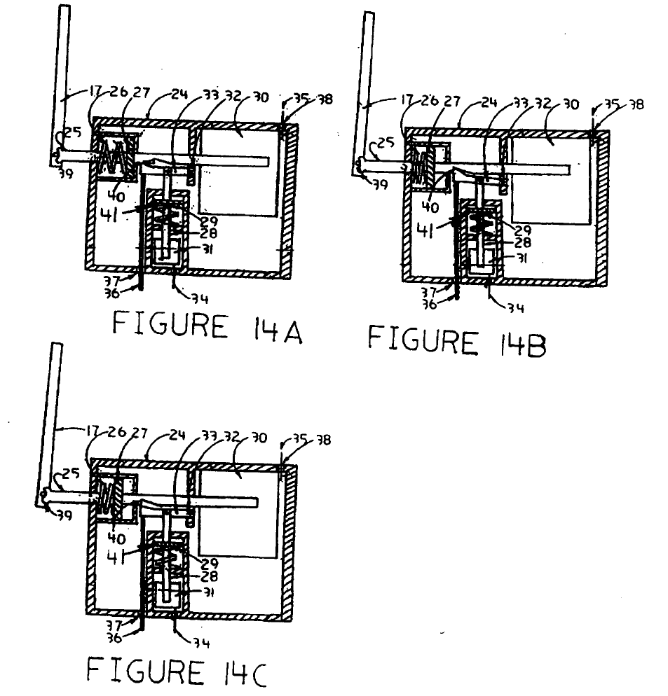

In yet another embodiment of the present invention, FIG. 9 combines fuel filling, the flow of fuel to the engine, pressure relief, pressure relief in case of an accident and the communication with oxygen sensors, gas pressure sensors and any other sensors in one port upon the gas cylinder (61). The use of a single port on a gas cylinder (61) for all functions has several advantages listed above. Pressure relief from heat occurs as pressure inside the gas cylinder (203) overcomes a high strength pressure relief spring inside the control shaft (204) so that the probe pressure relief outlet port (205) aligns with the sleeve chamber pressure relief pipe (206). Sintered material can be used for the surface of the pressure relief outlet port (205) to prevent extrusion for high pressure applications. A spring is placed within the critical fuel control shaft (316).

Both the pressure relief system and the accident pressure relief system rely on the probe movement stops (210) to prevent to probe pressure relief outlet port (205) from overshooting the sleeve chamber pressure relief pipe (206) as shown in FIG. 9.

This hose which acts like a spring (327) in FIG. 13 allows for the passage of fuel when the car is being filled with fuel while it acts like a pressure relief spring when the ignition is off. Resistance to movement for this hose which acts like a spring (327) is provided by the contact between a sensor wire tee joint (193) and the ignition off pressure valve control stop (336) as shown in FIGS. 15 and 16. These provide resistance to the force of gas pressure inside the gas cylinder (61) and the control shaft spring inside the gas cylinder (325) when the ignition is off. The hose which acts like a spring (327) should have threaded hose fittings (332) on both ends which prevent the leakage of gas. It should also have spring like qualities in its walls, either from an actual spring or from the nature of the polymer itself. To prevent buckling of the hose which acts like a spring (327) it should be surrounded by an outer hose support pipe (329). The hose should be manufactured with reinforcement from an inner supporting pipe (330) to prevent inner buckling. The inner supporting pipe (330) is unthreaded and unattached at the other end to allow for compression of the hose which acts like a spring (327) by the gas pressure's force (331).

FIG. 14A shows a pressure relief control housing for actuating a test lever on a conventional pressure relief valve. This pressure relief control housing could also actuate a hollow shaft valve for pressure relief or a multi-function fuel control shaft for pressure relief. The pressure relief control housing (24) contains two solenoids: the pressure relief lever stem solenoid (30) and the release stem solenoid (31). The pressure relief lever stem solenoid (30) is activated by the same electronic signal which operates the air bag system of the automobile in the instance of an accidental impact. This signal is delivered through the pressure relief signal wires (35). When this signal occurs the pressure relief lever stem solenoid (30) motivates the pressure relief lever stem (25) and the pressure relief lever disc (27) to overcome the natural position of the pressure relief lever spring (26) and move the test lever (17) by way of the test lever pin grip (39) to a position so that gas pressure is released through a conventional pressure relief valve (50) as shown in FIG. 7.

The release lever (33) is then motivated by the natural position of the release spring (29) into the notch (40) as the pressure relief lever stem (25) moves. This state is shown in FIG. 14B. When the signal caused by the accident is removed the release lever (33) holds the pressure relief lever stem (25) in the open position. This is important in case the electrical system of the car is damaged during the accident in which case the open signal could be terminated before a second aspect of the collision damages the fuel system. The release stem (28) is motivated by the natural position of the release spring (29) to keep the release lever (33) in the notch (40) until a timed signal from the air bag system comes over the release signal wires (34). This signal motivates the release disc (41) and the release stem solenoid (31) to overcome the release spring (29). The release lever (33) then pivots on the release lever pin (32) from the notch (40) so that the pressure relief lever spring (26) can return to its natural position and the test lever (17) can close the pressure relief valve (50). The moment when the release lever (33) is removed from the notch (40) is shown in FIG. 14C.

If the timed release signal is invalidated by a failure of the car's electrical system a manual release cable (36) is pulled through a manual release cable washer (37) in the wall of the pressure relief cable housing (24). The manual release cable (36) may have a handle on the car's dashboard like a trunk release.

In some accidents the automobiles electrical system will be damaged after the collision signal is sent out the air bag system may become unable to send out the time delayed release signal. In this instance the pressure relief valve (50) will continue to relieve gas pressure until a manual release lever on the cars dashboard is activated. The system may also have means to periodically test the response time of the actuation.

Pressure relief during a collision can be extended to parked car whose ignition is off by maintain a small amount of power to the air bag sensor system and the solenoid system for pressure relief during a collision.

FIG. 15 shows the schematic for a possible configuration when the hose which acts like a spring (327) is compressed to allow gas movement during pressure relief (363). This system also shows a grease fitting (361) to help lubricate the system and an automobile frame extension (362) to support the pressure valve control stop (336). The fuel fill pipe retainer ring (96), the sintered hollow shaft valve outlet port (312), the cork apparatus (92) and the control shaft spring inside the gas cylinder (325) are also shown. The control spring inside the gas cylinder (325) may have a spark resistant coating.

FIG. 16 shows yet another embodiment of the present invention. The ignition off solenoid (335) maintains the control shaft's position while the car is not operating against the force of pressure inside the gas cylinder (61). Solenoid (335) is always on when the ignition is on and always off when the ignition is off. The normal position of the solenoid (335), when the ignition is off, stops the control shaft from moving away from the pressure tank by placing a pressure valve control stop (336) in the way of some appendage on the fuel control shaft (311) such as the sensor wire tee joint (193). This resists the pressure of the compressed gas against the fuel control shaft (311) in a solid manner. When the ignition is on this solenoid removes the pressure valve control stop (336) from the fuel control shaft (311) and triggers an ignition off solenoid monitoring switch (338) so that the driver is assured that failure of this solenoid will not affect the accident pressure relief action of the fuel control system. The accident latching solenoid (337) is activated to maintain the system in its venting position in case the car's electrical system is damaged in an accident as will be discussed later.

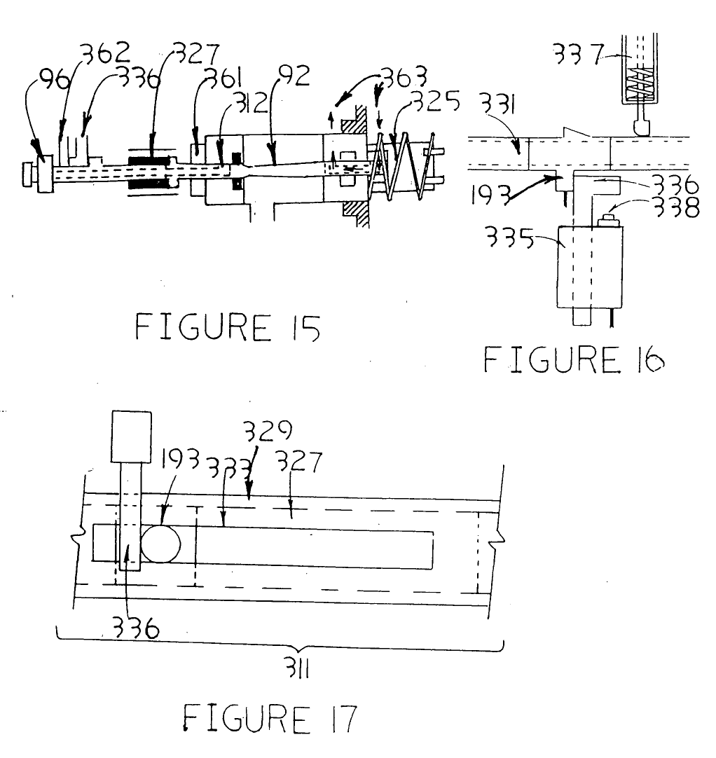

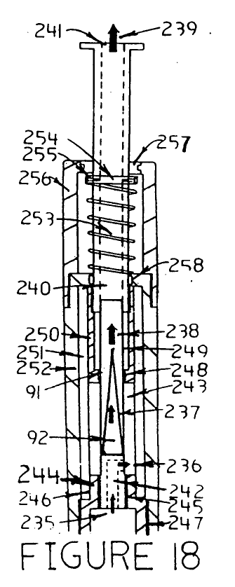

In yet another embodiment of the present invention, FIG. 17 illustrates the rotation of the fuel control shaft (311) is prevented. The outer hose support pipe (329) may have a tee joint movement channel (333) which orients the sensor wire tee joint (193) as it moves during the movement of the fuel control shaft (311). The hose which acts like a spring (327) is again contained within the outer hose support pipe (329). The pressure valve control stop (336) resists the motion of the sensor wire tee joint (193) to allow for compression of the hose which acts like a spring (327).

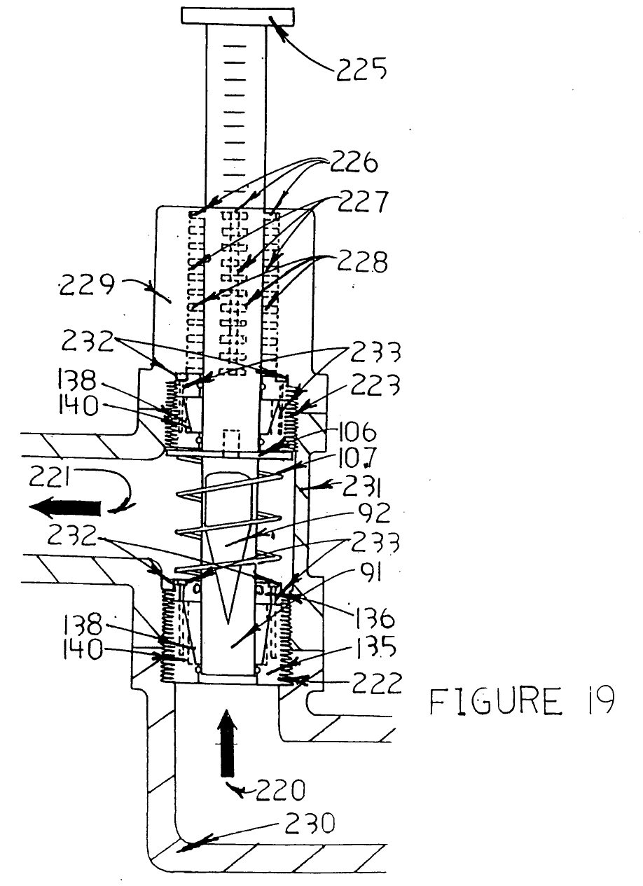

FIG. 18 shows how a utilization of the variable shaft valve for use in a public water fountain or other variable flow valve where a sliding fluid control tube (240) slides over a cork groove (92) to allow for varying flow of water through the device.

In yet another embodiment of the present invention, FIG. 19 shows a valve design used for venting chlorine into drinking water and in other similar processes where the mixing rate or drip rates of a fluid into a process require precision. The pressure in these applications and others using liquid may be determined by the height of the water column of the liquid which feeds into the inlet pressure. The force of gravity can be used to provide a reliable pressure source on some applications such as the addition of sodium hypochlorite solution, or some other liquid, to the inlet side of the variable shaft valve.

FIG. 19 also illustrates an indexed cork controlled shower faucet valve (224) which could be pressurized by standard residential water pressure. This valve controls the rate of flow of the inlet water (220) as it flows through the shower inlet sleeve retainer (222) by sliding a cork apparatus (91) through the shower inlet sleeve retainer (222). The inlet sleeve retainer is shown in FIG. 15. When the cork grooves (92) do not join flow from the shower inlet flow (220) to the shower outlet flow (221) the flow of water to the shower head is stopped. The shower control sleeve retainer (223) prevents leakage of water and its threads join the shower handle guide (229) to the shower control tee joint (231). The lower two piece o-ring retainer (135) and the upper two piece o-ring retainer (136) are joined to act as a unit whose threads join the shower control tee joint (231) to the shower inlet elbow (230).

FIG. 19 also shows a bayonet system to fix the longitudinal position of the valve by matching shower control posts (226) in post position maintenance grooves (228) which are connected for longitudinal movement of the unit by travel channels (227. While the shower handle guide (229) in FIG. 19 is cast as a single item, it could also be a two piece item in which one half contains a cylindrical bore for the shaft and the other half contains post position maintenance grooves (228) which have been routered, the two halves being fastened together to act as a single unit.

Numerous modifications, variations, and adaptations may be made to the particular embodiments of the invention described above without departing from the scope of the invention, which is defined in the claims.

1. A valve controlling flow of gas or liquid comprising:
a housing having a wall with an inner surface, the inner surface defining a channel,
a seal in said channel,
a shaft movable longitudinally through said channel between a position that prevents flow to a position that permits flow, and,
one or more means on said shaft for controlling flow through said seal.

2. A valve as claimed in claim 1, wherein the means on said shaft for controlling flow through said seal is a diametric reduction of the shaft on one side of said seal and movement of the diametric reduction into said seal permits flow through the seal.

3. A valve as claimed in claim 1, wherein the means on said shaft for controlling flow through said seal is a longitudinal channel within part of said shaft having two or more outlets perpendicular to the longitudinal axis of said longitudinal channel and longitudinal movement of the shaft controls flow through the longitudinal channel.

4. A valve according to claim 3, wherein longitudinal movement of the shaft causes at least two of said perpendicular outlets on opposite sides of said seal permit flow from one side of said seal to the other.

5. A valve according to claim 3, wherein longitudinal movement of the shaft aligns one or more perpendicular outlets with corresponding ports in said housing to permit flow through the seal.

6. A valve according to claim 5, wherein one or more corresponding ports are within said seal.

7. A valve as claimed in any one of claim 2, further comprising sensor wires.

8. A valve as claimed in any one of claim 2, wherein said shaft moves in response to a detected change in condition.

9. A valve according to claim 8, wherein said change in condition is a signal.

10. A valve according to claim 9, wherein said signal is a change in oxygen level.

11. A valve as claimed in claim 8, wherein said signal is a change in chlorination levels.

12. A valve as claimed in claim 8, wherein said change in condition is a mechanical change.

13. A valve as claimed in any one of claims 2 to 3, wherein said shaft moves manually.

14. A valve as claimed in claim 9, wherein said signal is an airbag sensor.

15. A valve as claimed in any one of claims 2 to 3, further comprising multiple means in series on the same said shaft for controlling flow through said seal.
